(19) United States
(12) Patent Application Publication
(10) Pub. No.: US 2023/0352002 A1
(43) Pub. Date: Nov. 2, 2023

(54) AUTOMATICALLY EXTRACTING INFORMATION FROM CONVERSATION TEXT DATA USING MACHINE LEARNING TECHNIQUES

(71) Applicant: Dell Products L.P., Round Rock, TX (US)

(72) Inventors: Zijia Wang, WeiFang (CN); Jiacheng Ni, Ruili (CN); Victor Fong, Melrose, MA (US); Zhen Jia, Shanghai (CN)

(21) Appl. No.: 17/731,513

(22) Filed: Apr. 28, 2022

(51) Int. Cl. G10L 15/06; G10L 15/16; G06N 20/20

(52) U.S. Cl. CPC G10L 15/063; G10L 15/16; G06N 20/20

(57) ABSTRACT

Methods, apparatus, and processor-readable storage media for automatically extracting information from conversation text data using machine learning techniques are provided herein. An example computer-implemented method includes generating one or more embeddings from conversation text data by processing at least a portion of the conversation text data using a first set of machine learning techniques; extracting information associated with one or more predefined categories from at least one set of input conversation text data by processing at least a portion of the at least one set of input conversation text data using a second set of machine learning techniques in connection with at least a portion of the one or more embeddings; and performing one or more automated actions based at least in part on the extracted information.

### FIELD

The field relates generally to information processing systems, and more particularly to techniques for processing text data.

### BACKGROUND

A common challenge for conventional speech processing techniques includes being able to extract local information from conversations between two or more people. For example, an enterprise's support line may wish to extract structured information about each caller's issue (e.g., the product, details of the issue, etc.). Such information can be referred to as local information, as the information can be inferred from a segment of the conversation (as opposed to an overall topic of the conversation). Accordingly, conventional speech processing techniques typically fail to extract and/or identify such local information from conversation data.

### SUMMARY

Illustrative embodiments of the disclosure provide techniques for automatically extracting information from conversation text data using machine learning techniques. An exemplary computer-implemented method includes generating one or more embeddings from conversation text data by processing at least a portion of the conversation text data using a first set of machine learning techniques. The method also includes extracting information associated with one or more predefined categories from at least one set of input conversation text data by processing at least a portion of the at least one set of input conversation text data using a second set of machine learning techniques in connection with at least a portion of the one or more embeddings. Additionally, the method includes performing one or more automated actions based at least in part on the extracted information.

Illustrative embodiments can provide significant advantages relative to conventional speech processing techniques. For example, problems associated with the inability to extract local information from conversations are overcome in one or more embodiments through automatically extracting trained categorical information from conversation text data using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically extracting information from conversation text data using machine learning techniques in an illustrative embodiment.

FIG. 2 shows examples of defined input and output sequences for multiple types of encoders in an illustrative embodiment.

FIG. 3 shows an example workflow for pain point extraction in an illustrative embodiment.

FIG. 4 is a flow diagram of a process for automatically extracting information from conversation text data using machine learning techniques in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

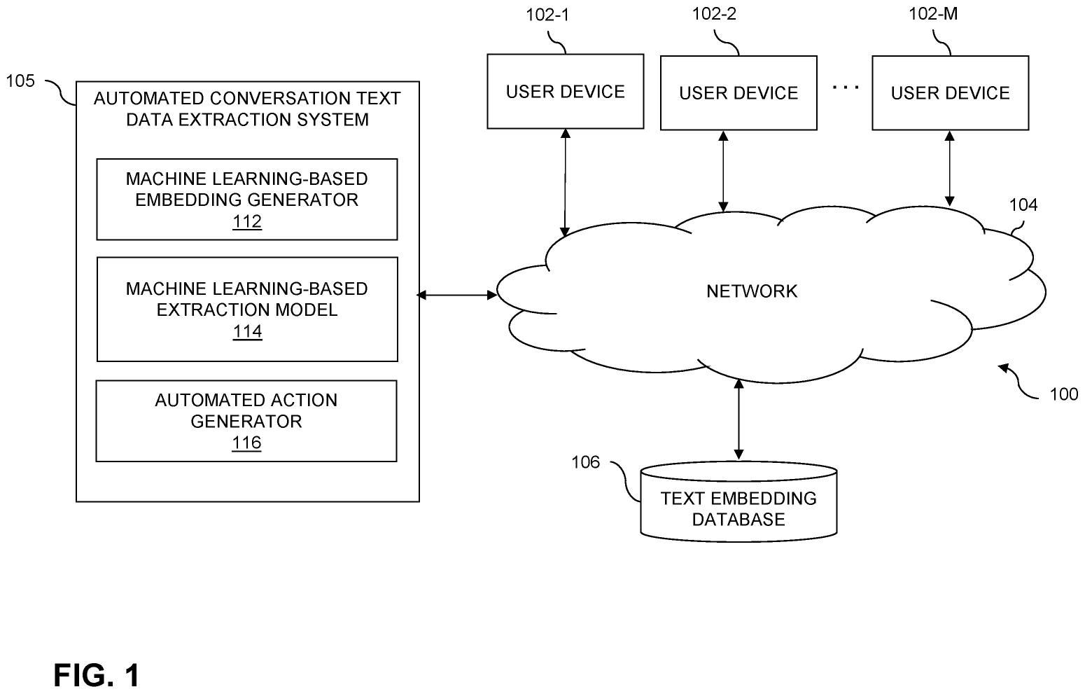

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated conversation text data extraction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated conversation text data extraction system 105 can have an associated text embedding database 106 configured to store data pertaining to embeddings and related information derived from conversational text data.

The text embedding database 106 in the present embodiment is implemented using one or more storage systems associated with automated conversation text data extraction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated conversation text data extraction system 105 are one or more input-output devices, which illustratively comprise keyboards, displays or other types of input-output devices in any combination. Such input-output devices can be used, for example, to support one or more user interfaces to automated conversation text data extraction system 105, as well as to support communication between automated conversation text data extraction system 105 and other related systems and devices not explicitly shown.

Additionally, automated conversation text data extraction system 105 in the FIG. 1 embodiment is assumed to be implemented using at least one processing device. Each such processing device generally comprises at least one processor and an associated memory, and implements one or more functional modules for controlling certain features of automated conversation text data extraction system 105.

More particularly, automated conversation text data extraction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated conversation text data extraction system 105 to communicate over the network 104 with the user devices 102, and illustratively comprises one or more conventional transceivers.

The automated conversation text data extraction system 105 further comprises machine learning-based embedding generator 112, machine learning-based extraction model 114, and automated action generator 116.

It is to be appreciated that this particular arrangement of elements 112, 114 and 116 illustrated in the automated conversation text data extraction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically extracting information from conversation text data using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated conversation text data extraction system 105 and text embedding database 106 can be on and/or part of the same processing platform.

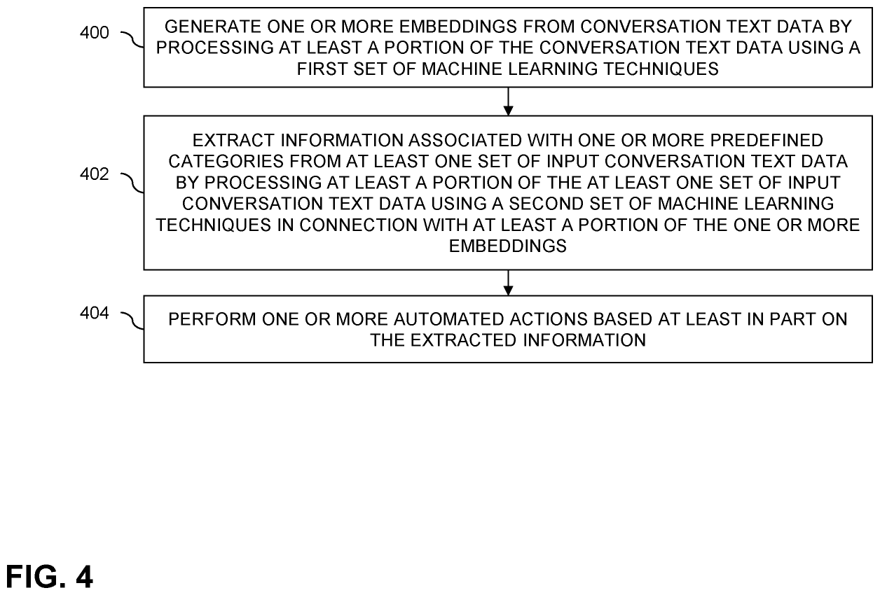

An exemplary process utilizing elements 112, 114 and 116 of an example automated conversation text data extraction system 105 in computer network 100 will be described in more detail with reference to the flow diagram of FIG. 4.

Accordingly, at least one embodiment includes automatically extracting multi-phase pain-point information from conversation data. As detailed herein, such an embodiment includes using dense embeddings to represent text, and clustering at least a portion of those embeddings (e.g., vectors) in connection with implementation of semi-supervised learning techniques. As used herein, embeddings can include one or more vectors that represent the sentence(s) in a dialogue in a statistical way. Such semi-supervised learning techniques can be used, for example, to process a collection of transcripts of conversations between two or more individuals, wherein only a portion of the transcripts are labeled with one or more items of information.

As such, one or more embodiments include leveraging unlabeled data to train at least one model (e.g., recurrent neural network (RNN)) for extracting pain point information from conversation data. Also, such an embodiment includes implementing a pre-training framework (e.g., machine learning-based embedding generator 112) for conversations generated in connection with transcription data processed using one or more artificial intelligence-based transcription techniques. Additionally, based at least in part on the pre-training framework, one or more embodiments include performing unsupervised synonym and/or concept extraction from natural language text data.

As further detailed herein, in connection with the above-noted pre-training framework, at least one embodiment includes processing conversation data using at least one RNN. In one or more example embodiments, such an RNN can be deployed on at least one centralized component (e.g., a server) and/or on one or more edge devices (e.g., user devices). Also, and as further detailed herein, based at least in part on embeddings learned via the RNN, an unsupervised information extraction model is implemented to extract one or more items information from input conversation data. In at least one embodiment, as further detailed herein, learning the embeddings can include steps of skip turn prediction techniques and next turn prediction techniques, wherein the embedding is input and the model is queried to predict the next one or more sentences.

One or more embodiments, in generating and/or implementing a pre-training framework, can include using, for example, a neural network-based tool that produces static word embeddings (e.g., word2vec), an artificial intelligence technique for dynamic word embedding with long short-term memory (LSTM) (e.g., ELMo), a transformer-decoder-based autoregressive language model (e.g., a generative pre-trained transformer (GPT) model), a transformer-encoder-based autoencoder language model (e.g., bidirectional encoder representations from transformers (BERT)), an autoregressive language model (LM) and denoise autoencoder (DAE) model (e.g., XLNet), etc.

As also detailed herein, one or more embodiments include implementing at least one clustering algorithm used in this invention. For example, such an embodiment can include implementing a k-means clustering algorithm, an iterative algorithm that attempts to partition a dataset into k pre-defined distinct non-overlapping sub-groups (also referred to herein as clusters), wherein each data point can belong to only one sub-group. Also, such an algorithm attempts to render the intra-cluster data points as similar as possible, while also maintaining the clusters as different as possible. For example, in at least one embodiment, a k-means clustering algorithm assigns data points to a cluster such that the sum of the squared distance between the data points and the cluster's centroid (e.g., the arithmetic mean of all data points that belong to that cluster) is minimized and/or at a minimum value. The less variation there is within clusters, the more homogeneous (similar) the data points are within the same cluster.

In at least one embodiment, a k-means clustering algorithm is implemented as follows. A number of clusters (k) is specified, and corresponding centroids are initialized by shuffling the given dataset (e.g., reordering the data points) and randomly selecting k data points for the centroids without replacement. Such an embodiment also includes iterating such steps until there is no change to the centroids (i.e., assignment of data points to clusters is not changing). Subsequently, the sum of the squared distance between data points and all centroids is computed, and each data point is assigned to the closest cluster (centroid). Also, the centroids for the clusters can be computed by taking the average of the data points that belong to each cluster.

Additionally or alternatively, in one or more embodiments, implementing a k-means clustering algorithm includes performing an expectation-maximization technique. The E-step (i.e., expectation) includes assigning data points to the closest cluster (i.e., closest to the given data point(s)), and the M-step (i.e., maximization) includes computing the centroid of each cluster. Mathematically, performing such an expectation-maximization technique can include solving an objective function such as:

$$J = {\sum }_{i = 1}^{m} {\sum }_{k = 1}^{K} {w}_{i k} {‖ {x}^{i} - {μ}_{k} ‖}^{2}$$

wherein wᵢₖ=1 for data point xⁱ if the data point belongs to cluster k; otherwise, wᵢₖ=0. Also, μₖ represents the centroid of xᵢ's cluster, J represents the loss, and m represents the number of data points.

Such an objective function represents a minimization problem of two parts: minimize J with respect to wᵢₖ and treating μₖ as fixed; and minimizing J with respect to μₖ and treating wᵢₖ as fixed. By way of example, one or more embodiments can include differentiating J with respect to wᵢₖ first, and correspondingly updating the cluster assignments (e.g., via the E-step). Then, such an embodiment can include differentiating J with respect to μₖ and recomputing the centroids after the cluster assignments from previous step (e.g., via the M-step). Therefore, in such an embodiment, the E-step includes the following:

$$\frac{\partial J}{\partial {w}_{i k}} = {\sum }_{i = 1}^{m} {\sum }_{k = 1}^{K} {‖ {x}^{i} - {μ}_{k} ‖}^{2}$$

$$⇒ {w}_{i k} = \{ \begin{matrix}1 if k = arg {min}_{j} {‖ {x}^{i} - {μ}_{j} ‖}^{2} \\ 0 otherwise\end{matrix}$$

In other words, one or more embodiments include assigning the data point xⁱ to the closest cluster judged by the sum of squared distance of the data point from cluster's centroid. Additionally, in such an embodiment, the M-step includes the following:

$$\frac{\partial J}{\partial {w}_{i k}} = 2 {\sum }_{i = 1}^{m} {w}_{i k} ( {x}^{i} - {μ}_{k} ) = 0$$

$$⇒ {μ}_{k} = \frac{{\sum }_{{i}_{1}}^{m} {w}_{i k} {x}^{i}}{{\sum }_{i - 1}^{m} {w}_{i k}}$$

In other words, one or more embodiments include recomputing the centroid of each cluster to reflect new assignments.

As such, and as further described herein, at least one embodiment includes generating and/or implementing a framework that includes an unsupervised pre-training component and a semi-supervised training component.

Unsupervised pre-training for conversation data can include pre-training at least one RNN encoder as part of an encoder-decoder (also known as sequence-to-sequence) model. In one or more embodiments, this class of models can be utilized to solve the following problem: given a pair of token-sequences (x, y), wherein x=(x₁, . . . , xₘ) and is referred to as the input sequence, and y=(y₁, . . . , yₙ) and is referred to as the output sequence, such an embodiment includes maximizing P(y|x). As further detailed below, such a model contains an RNN encoder and an RNN decoder.

In one or more embodiments, the RNN encoder consumes an input sequence x, one token at a time, to produce a hidden state, h(x). Conceptually, this is a dense vector representation of the sequence x. Subsequently, the RNN decoder estimates an output distribution over sequences y, conditional on h(x). Maximizing P(y|x) over a training corpus forces the encoder to learn to compactly represent particular information (e.g., the most important information, as predefined, for example, by one or more users) from the input sequence.

In at least one embodiment, pre-training includes enabling and/or facilitating training such a model (e.g., an encoder-decoder model) on one task for which there is a large amount of unlabeled data, and then re-applying what the model has learned to another task with less labeled data. In such an embodiment, using, for example, the above-noted encoder-decoder model, the input sequence x can include tokens comprising a turn of dialogue. With respect to a “turn” of a dialogue, consider an example wherein Person A says sentence A1, then Person B says sentence B, then Person A says sentence A2. In this example, there are three turns. As such, the encoder, in this instance, will learn a dialogue turn representation.

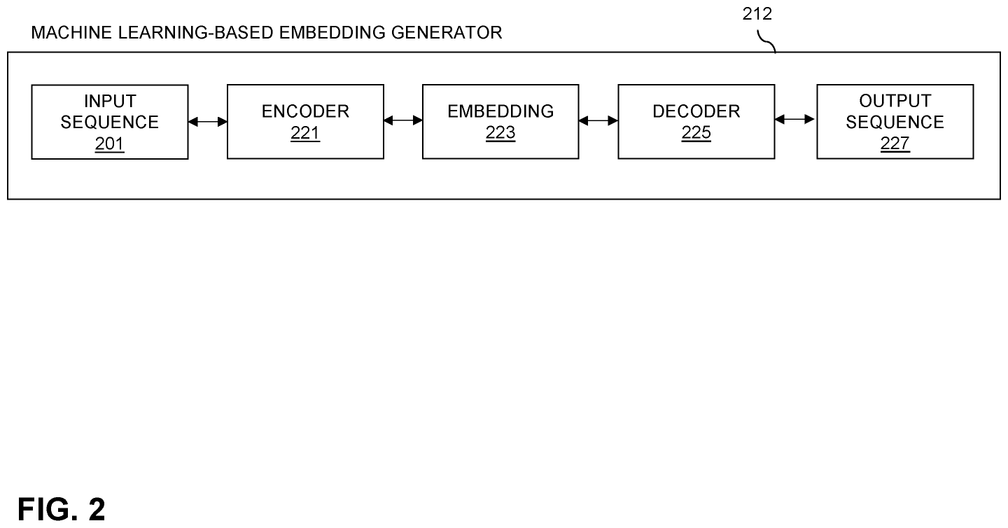

FIG. 2 shows examples of defined input and output sequences for multiple types of encoders in an illustrative embodiment. By way of illustration, FIG. 2 depicts machine learning-based embedding generator 212 (part of, in one or more embodiments, the pre-training framework), which includes an input sequence 201, which is processed using encoder 221 to generate at least one embedding 223. The at least one embedding 223 is then processed using decoder 225 to generate an output sequence 227. As described below and further detailed herein, encoder 221 can comprise one or more components and/or techniques. Because the encoder 221 is trained to be effective in predicting y, the way in which y is defined can impact the representation of x, a dialogue turn, that is learned. Accordingly, one or more embodiments include determining and/or understanding how the definition of y in an unsupervised pre-training stage impacts the performance of a supervised classification model. In connection therewith, in at least one embodiment, encoder 221 can comprise an autoencoder, next-turn prediction techniques, and/or skip-turn prediction techniques.

With respect to the following descriptions, consider an example input sequence comprising:
Turn1: Patient: I am experiencing pain when I walk.
Turn2: Doctor: Can you show me where?
Turn3: Patient: Here, across my torso.

Accordingly, at least one embodiment can include training a sequence autoencoder, which results in the output sequence y being identical to the input sequence x. In other words, the autoencoder model is trained to learn to reconstruct a dialogue turn itself. In order for a corresponding decoder (e.g., decoder 225) to reconstruct a sequence given only h(x), wherein h(x) represents the hidden state, the autoencoder must learn a compact representation of the sequence. In at least one embodiment, training an autoencoder includes inputting sequence x, then using an encoder to generate h(x). Then, h(x) becomes the input of the decoder, and the decoder attempts to generate y, which should be identical to x. Further, at least one similarity measurement can be used in connection with the loss. By way merely of illustration, given Turn3 of the example input sequence noted above, an autoencoder can generate an output of “Patient: Here, across my torso.”

Additionally or alternatively, one or more embodiments can include implementing next-turn prediction techniques in connection with an encoder and unsupervised pre-training. In such an embodiment, given an input sequence xₜ, the output sequence y is xₜ+1. Accordingly, such an embodiment includes training the encoder to learn about the semantic intent of xₜ, rather than simply the lexical features of xₜ, in order to predict the reply xₜ+1. For example, if xₜ contains a question, the encoder, using next-turn prediction techniques, can encapsulate this to predict the next speaker's answer. By way merely of illustration, given Turn1 of the example input sequence noted above, an encoder implementing next-turn prediction techniques can generate an output of “Can you show me where?”

Additionally or alternatively, one or more embodiments can include implementing skip-turn prediction techniques, which predict not just the next turn but one or more other nearby turns as well. For example, given input sequence xₜ, such an embodiment includes creating 2k different input examples: (xₜ, xₜ₋ₖ), (xₜ, xₜ₋ₖ₊₁), . . . (xₜ, xₜ₋₁), (xₜ, xₜ₊₁), . . . (xₜ, xₜ₊ₖ₋₁), (xₜ, xₜ₊ₖ) for some value of k. The premise of such models is that a word or sentence is defined by its context words or sentences, and here, in such an embodiment, the same concept is applied to dialogue turns. By way merely of illustration, given Turn2 of the example input sequence noted above, an encoder implementing skip-turn prediction techniques can generate an output of “Patient: I am experiencing pain when I walk” as well as an output of “Here, across my torso.”

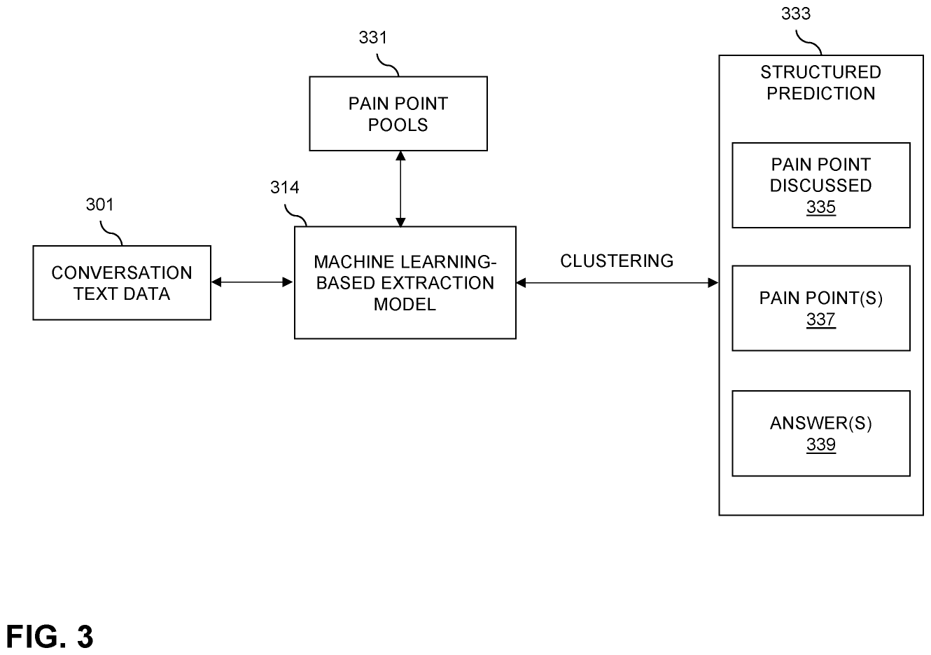

In addition to implementation of a pre-training framework (e.g., machine learning-based embedding generator 212 such as depicted in FIG. 2) one or more embodiments includes implementing semi-supervised training for pain point extraction. By way of example, FIG. 3 shows an example workflow for pain point extraction in an illustrative embodiment. By way of illustration, FIG. 3 depicts conversation text data 301 (e.g., dialogues), which is processed by machine learning-based extraction model 314, which is trained at least in part using data from pain point pools 331 (which can be derived, for example, from one or more experts and/or business units). As also depicted in FIG. 3, machine learning-based extraction model 314 processes at least a portion of conversation text data 301 (which can include, for example, portions of output generated by a machine learning-based embedding generator such as element 112 in FIG. 1 and element 212 in FIG. 2) using at least one k-means algorithm, with the cluster number representing the number of pain points in pain point pools 331.

Also, in connection with an example embodiment such as depicted in FIG. 3, the clustering performed by machine learning-based extraction model 314 facilitates extraction of topics from the centered dialogue (derived from conversation text data 301) in each cluster. In one or more embodiments, topic extraction includes using a topic-related model, wherein the input is the dialogue while the output includes one or more topics of the dialogue. Subsequently, at least a portion of the extracted topics are aligned with one or more pain points to assign pain points to the clusters. In at least one embodiment, such topic alignment can be carried out using, for example, BERT to extract an embedding for the extracted topics and all related pain points, and then using a cosine similarity to determine the nearest pain points. Such actions can result, as depicted in FIG. 3, with one or more structure predictions 333, which can include the pain point(s) discussed 335 (in conversation text data 301), the paint point(s) 337 identified from pain point pools 331, and the answer(s) 339 provided (in conversation text data 301). Accordingly, in one or more embodiments, if the similarity between the topics of the given dialogue and at least a portion of the given pain points are sufficiently low, the dialogue is labeled as ‘no pain point has been discussed,’ and in such an instance, there is only this output (that is, without pain point(s) 337 and answer(s) 339); otherwise, the dialogue can be labeled as “pain point discussed,” (e.g., element 335) and concrete pain point(s) (e.g., element 337) and answer(s) (e.g., element 339) can also be output.

By way of example, with respect to pain point(s) discussed 335, if one dialogue is assigned to one cluster with a low confidence score, then this dialogue will be viewed as not discussing a pain point. Also, in one or more embodiments, the answer(s) 339 part of a dialogue can be separated from the (whole) dialogue and compared with the pain points in the pain point pools 331 using one or more distance-based metrics. For example, if the distance is low enough (e.g., below a given threshold value), then the corresponding dialogue is assigned with “yes” for the “answered” field; otherwise, this field is filled with a “no” indication.

Also, in one or more embodiments, linking an unsupervised pre-training framework (such as detailed in connection with FIG. 2, for example) and semi-supervised training (such as detailed in connection with FIG. 3, for example) includes initializing the RNN encoder with weights from the RNN encoder, and facilitating the machine learning-based extraction model to continue training based at least in part thereon. Accordingly, in such an embodiment, the unsupervised pre-training framework should teach the RNN how to effectively and compactly encode the meaning of a given turn (e.g., portion of conversation text data), while the semi-supervised training should include learning how to apply this (encoded) representation to a classification task.

Such a method can also be generalized, for example, to cases wherein multiple turns of context may be required for classification. For such a scenario, one or more embodiments can include selecting a context window size k and training an encoder to encode a segment of k consecutive turns (of dialogue and/or conversation). In other words, during pre-training, the input sequence can include turns

$${x}_{t} - \frac{k - 1}{2} , … , {x}_{t} , … , {x}_{t} + \frac{k - 1}{2}$$

concatenated together. In such an embodiment, the output sequence can also include k turns: the same k turns for the autoencoder, the next k turns for next-turn prediction techniques, and the previous and/or next k turns for skip-turn prediction techniques. In the semi-supervised training stage, such an embodiment can include continuing to use the same context of k turns and initializing the encoder from the first stage (that is, the pre-training stage).

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 4 is a flow diagram of a process for automatically extracting information from conversation text data using machine learning techniques in an illustrative embodiment. It is to be understood that this particular process is only an example, and additional or alternative processes can be carried out in other embodiments.

In this embodiment, the process includes steps 400 through 404. These steps are assumed to be performed by automated conversation text data extraction system 105 utilizing elements 112, 114 and 116.

Step 400 includes generating one or more embeddings from conversation text data (e.g., input data) by processing at least a portion of the conversation text data using a first set of machine learning techniques. In at least one embodiment, the first set of machine learning techniques includes at least one encoder-decoder model. In such an embodiment, processing at least a portion of the conversation text data using the first set of machine learning techniques can include implementing, in conjunction with the at least one encoder-decoder model, at least one of an autoencoder, one or more next-turn prediction techniques, and one or more skip-turn prediction techniques. Additionally or alternatively, processing at least a portion of the conversation text data using the first set of machine learning techniques can include initializing an encoder of the at least one encoder-decoder model with one or more weights. Further, in such an embodiment, processing at least a portion of the conversation text data using the first set of machine learning techniques can include selecting a context window size and training an encoder of the at least one encoder-decoder model to encode consecutive segments of the conversation text data, wherein the consecutive segments number an amount equal to the selected context window size.

Additionally or alternatively, the first set of machine learning techniques can include one or more unsupervised learning techniques and/or at least one recurrent neural network model.

Step 402 includes extracting information associated with one or more predefined categories from at least one set of input conversation text data by processing at least a portion of the at least one set of input conversation text data using a second set of machine learning techniques in connection with at least a portion of the one or more embeddings. In one or more embodiments, the second set of machine learning techniques can include one or more semi-supervised learning techniques and/or at least one k-means clustering algorithm.

Step 404 includes performing one or more automated actions based at least in part on the extracted information. In at least one embodiment, performing one or more automated actions includes automatically training at least one of the first set of machine learning techniques and the second set of machine learning techniques based at least in part on the extracted information. Additionally or alternatively, performing one or more automated actions can include automatically outputting at least a portion of the extracted information to one or more of at least one user and at least one system (e.g., in connection with generating and/or outputting one or more recommendations).

Also, in one or more embodiments the first set of machine learning techniques can include at least a portion of the same techniques as the second set of machine learning techniques.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically extract information from conversation text data using machine learning techniques. These and other embodiments can effectively overcome problems associated with the inability to extract local information from conversations.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

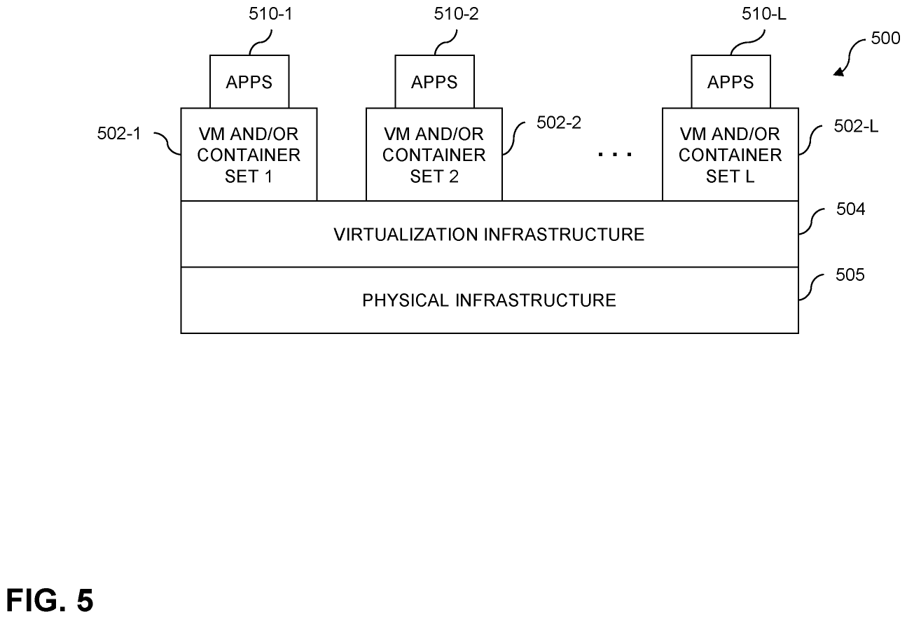

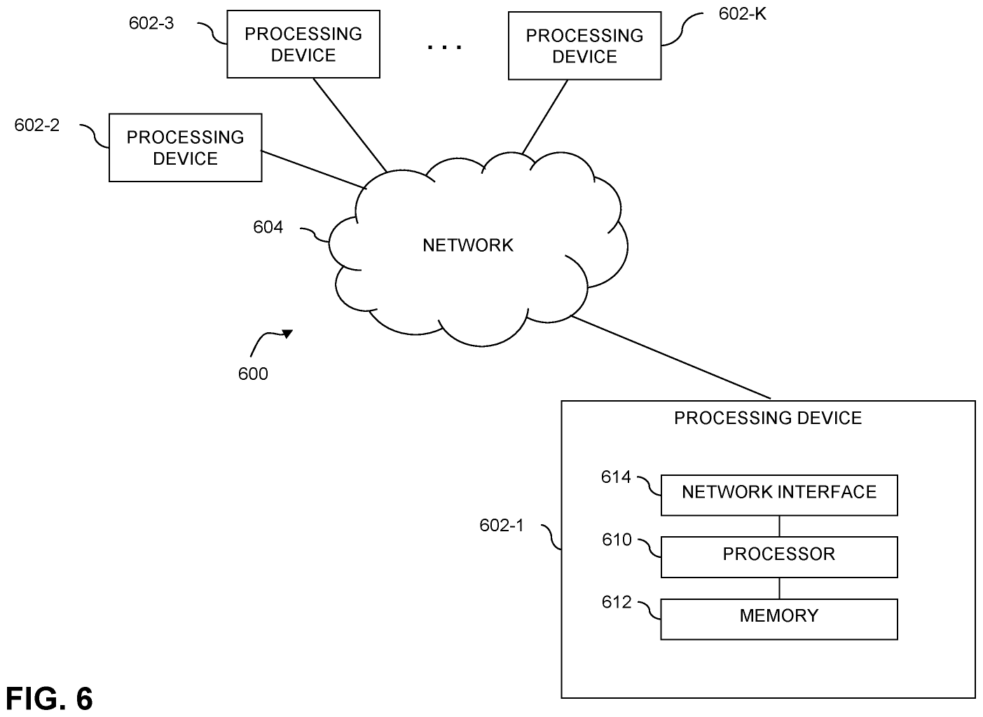

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
generating one or more embeddings from conversation text data by processing at least a portion of the conversation text data using a first set of machine learning techniques;
extracting information associated with one or more predefined categories from at least one set of input conversation text data by processing at least a portion of the at least one set of input conversation text data using a second set of machine learning techniques in connection with at least a portion of the one or more embeddings; and
performing one or more automated actions based at least in part on the extracted information;
wherein the method is performed by at least one processing device comprising a processor coupled to a memory.

2. The computer-implemented method of claim 1, wherein the first set of machine learning techniques comprises at least one encoder-decoder model.

3. The computer-implemented method of claim 2, wherein processing at least a portion of the conversation text data using the first set of machine learning techniques comprises implementing, in conjunction with the at least one encoder-decoder model, at least one of an autoencoder, one or more next-turn prediction techniques, and one or more skip-turn prediction techniques.

4. The computer-implemented method of claim 2, wherein processing at least a portion of the conversation text data using the first set of machine learning techniques comprises initializing an encoder of the at least one encoder-decoder model with one or more weights.

5. The computer-implemented method of claim 2, wherein processing at least a portion of the conversation text data using the first set of machine learning techniques comprises selecting a context window size and training an encoder of the at least one encoder-decoder model to encode consecutive segments of the conversation text data, wherein the consecutive segments number an amount equal to the selected context window size.

6. The computer-implemented method of claim 1, wherein the first set of machine learning techniques comprises one or more unsupervised learning techniques.

7. The computer-implemented method of claim 1, wherein the first set of machine learning techniques comprises at least one recurrent neural network model.

8. The computer-implemented method of claim 1, wherein the second set of machine learning techniques comprises one or more semi-supervised learning techniques.

9. The computer-implemented method of claim 1, wherein the second set of machine learning techniques comprises at least one k-means clustering algorithm.

10. The computer-implemented method of claim 1, wherein performing one or more automated actions comprises automatically training at least one of the first set of machine learning techniques and the second set of machine learning techniques based at least in part on the extracted information.

11. The computer-implemented method of claim 1, wherein performing one or more automated actions comprises automatically outputting at least a portion of the extracted information to one or more of at least one user and at least one system.

12. A non-transitory processor-readable storage medium having stored therein program code of one or more software programs, wherein the program code when executed by at least one processing device causes the at least one processing device:
to generate one or more embeddings from conversation text data by processing at least a portion of the conversation text data using a first set of machine learning techniques;
to extract information associated with one or more predefined categories from at least one set of input conversation text data by processing at least a portion of the at least one set of input conversation text data using a second set of machine learning techniques in connection with at least a portion of the one or more embeddings; and
to perform one or more automated actions based at least in part on the extracted information.

13. The non-transitory processor-readable storage medium of claim 12, wherein the first set of machine learning techniques comprises at least one encoder-decoder model.

14. The non-transitory processor-readable storage medium of claim 13, wherein processing at least a portion of the conversation text data using the first set of machine learning techniques comprises implementing, in conjunction with the at least one encoder-decoder model, at least one of an autoencoder, one or more next-turn prediction techniques, and one or more skip-turn prediction techniques.

15. The non-transitory processor-readable storage medium of claim 13, wherein processing at least a portion of the conversation text data using the first set of machine learning techniques comprises initializing an encoder of the at least one encoder-decoder model with one or more weights.

16. The non-transitory processor-readable storage medium of claim 13, wherein processing at least a portion of the conversation text data using the first set of machine learning techniques comprises selecting a context window size and training an encoder of the at least one encoder-decoder model to encode consecutive segments of the conversation text data, wherein the consecutive segments number an amount equal to the selected context window size.

17. An apparatus comprising:
at least one processing device comprising a processor coupled to a memory;
the at least one processing device being configured:
to generate one or more embeddings from conversation text data by processing at least a portion of the conversation text data using a first set of machine learning techniques;
to extract information associated with one or more predefined categories from at least one set of input conversation text data by processing at least a portion of the at least one set of input conversation text data using a second set of machine learning techniques in connection with at least a portion of the one or more embeddings; and
to perform one or more automated actions based at least in part on the extracted information.

18. The apparatus of claim 17, wherein the first set of machine learning techniques comprises at least one encoder-decoder model.

19. The apparatus of claim 18, wherein processing at least a portion of the conversation text data using the first set of machine learning techniques comprises implementing, in conjunction with the at least one encoder-decoder model, at least one of an autoencoder, one or more next-turn prediction techniques, and one or more skip-turn prediction techniques.

20. The apparatus of claim 18, wherein processing at least a portion of the conversation text data using the first set of machine learning techniques comprises selecting a context window size and training an encoder of the at least one encoder-decoder model to encode consecutive segments of the conversation text data, wherein the consecutive segments number an amount equal to the selected context window size.
